(19) United States
(12) Patent Application Publication
(10) Pub. No.: US 2011/0025617 A1
(43) Pub. Date: Feb. 3, 2011

(54) HYBRID TOUCH PANEL

(75) Inventors: Lung-Sheng Hsih, Taipei (TW); Jane Hsu, Taoyuan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: MINLEAD LTD., Taipei (TW)

(21) Appl. No.: 12/694,598

(22) Filed: Jan. 27, 2010

(30) Foreign Application Priority Data
Aug. 3, 2009 (TW) 098214289

(51) Int. Cl. G06F 3/041

(52) U.S. Cl. 345/173

(57) ABSTRACT

A hybrid touch panel has a first substrate, a second substrate, and an insulation layer and a separating layer sandwiched between the first and second substrates. The first substrate has a first transparent electrode mounted thereon. A plurality of first electrodes are respectively mounted alongside edges of the first transparent electrode and are respectively connected with a plurality of first leading lines. The second substrate has a plurality of juxtaposed second transparent electrodes respectively corresponding to the first transparent electrode, a plurality of second electrodes respectively mounted on the second transparent electrodes and connected with a plurality of wires and second leading lines. Each second transparent electrode accompanying with the first transparent electrode forms an active areas. Accordingly, a multi-area touch panel can be constructed to enable a more smooth and flexible operation.

### BACKGROUND OF THE INVENTION

1. Field of the Invention

The present invention is related to a touch panel, and more particularly to a hybrid touch panel having a single panel with a plurality of active areas.

2. Description of the Related Art

Touch panels have been extensively applied to various walks of life nowadays. Related techniques are constantly upgraded and introduced. Current touch panels in the market are classified into resistive touch panels, capacitive touch panels, surface acoustic wave touch panels, infrared touch panels and so forth. Speaking of the market share, resistive touch panels rank top due to simple structure and low cost, capacitive touch panels rank second and take few tens of the market share, and the market shares of the rest of touch panels are really not so prominent. Resistive touch panels are advantageous in a simple structure and low cost but disadvantageous in single-touch detection and poor durability. Dominated by cost concern, special products such as hand writing pad are still developed based on resistive touch panel as number one choice.

Currently, the feature of multi-touch detection has already been available in capacitive touch panels. However, the involved technique associates with accurate and sophisticated computation. Such requirement makes the cost of capacitive touch panels remain at a high level and fails to meet economic benefits. As a result, this gives birth to matrix touch panels to fit that niche. The basic concept of matrix touch panels is similar to that of capacitive touch panels. The only difference is that matrix touch panels employ an etching method to divide the transparent electrode layer thereof into a plurality of independently and alternately aligned transparent electrodes, and the transparent electrodes on the second substrate and on the first substrate are intersected to take a form of matrix and each intersected point constitutes a capacitive switch.

With reference to FIG. 5, a matrix touch panel has a first substrate (70), a second substrate (80), an insulation layer (90) and a separating layer.

The first substrate (70) is composed of glass and has a transparent electrode layer on a surface thereof. The transparent electrode layer is etched to form a plurality of first transparent electrodes (71) independently juxtaposed. A plurality of wires (72) and a plurality of leading lines (72) are printed on edges of the surface of the first substrate (70) with silver paste. One terminal of each of the wires (72) is electrically connected with one end of a corresponding first electrode (71) and the other terminal is electrically connected with a corresponding leading line (73).

The second substrate (80) takes the form of a film. Beyond that, its structure is similar to that of the first substrate (70). A plurality of independently juxtaposed second transparent electrodes (81) are formed on a bottom surface of the second substrate (80). The second transparent electrodes (81) are intersected with the first transparent electrodes (71) in the form of a matrix. A plurality of wires (82) and a plurality of leading lines (83) are formed on a bottom surface of the second substrate (80) with silver paste. One terminal of each of the wires (82) is electrically connected with one end of the corresponding second transparent electrode (81) and the other terminal is electrically connected with a corresponding leading line (83).

The insulation layer (90) takes the form of a rectangular frame and the size thereof matches that of the first substrate (70) and of the second substrate (80). The insulation layer (90) is mounted between the first substrate (70) and the second substrate (80) to isolate the first substrate (70) from the second substrate (80).

The separating layer is composed of a plurality of spacers (91), and is located inside the insulation layer (90) and scattered between the first substrate (70) and the second substrate (80), thereby forming a gap between the first substrate (70) and the second substrate (80) before the touch panel is pressed.

The capacitance at the positions where the first transparent electrodes and the second transparent electrodes are intersected varies when the distances therebetween are changed. Accordingly, such nature allows a controller to determine where the coordinates of a touch spot are so as to easily implement the requirement of the multi-touch detection. The matrix touch panels provide stationary coordinates for users to pick, and they could be economic and practical choice when adopted to automatic transaction machine (ATM) or equipment with similar function. When the density of the transparent electrodes increases, such matrix touch panels could be adopted to equipment requiring higher resolution and accuracy.

However, the aforementioned matrix touch panels are not comparable with resistive touch panels in certain application, such as, hand writing pad.

Given mobile phones as an example, the input devices thereof mainly employ physical buttons as their input means. After the iPhone™ is launched by Apple™, the touch interface becomes an overwhelming trend, and its operational convenience is the one to praise. Regardless of the input means by physical buttons or touch buttons, the hand-writing demand is a portion that can not be ignored for sake of the hand-writing demand preferred by the group of customers unaccustomed to the button input means. Therefore, hand-writing pads are still the indispensable part of certain mobile phones. From the economic point of view, the resistive touch panel is ideal for the hand-writing pad. Whereas, it fails to meet the auxiliary requirement as a multi-touch interface because of its limitation in association with the single-touch detection, making the resistive touch panel situated in a dilemma. Some vendors attempt to provide mobile phones having a touch panel built with two different technical concepts to take the hand-writing and the multi-touch detection demands into account. However, such approach present difficulty in assembly and system integration, making it impractical and uneconomic.

### SUMMARY OF THE INVENTION

An objective of the present invention is to provide a hybrid touch panel advantageous in the simplicity of a resistive touch panel, low cost and the function of a hand-writing pad. Meanwhile, the multi-touch detection function provided by matrix touch panel can be also implemented, and the functionality of analog touch panel and digital touch panel can be integrated.

To achieve the foregoing objective, the hybrid touch panel has a first substrate, a second substrate, an insulation layer and a separating layer.

The first substrate has a top surface, a first transparent electrode, a plurality of first leading lines and a plurality of first electrodes.

The first transparent electrode is mounted on the top surface.

The plurality of first leading lines are mounted on a periphery of the top surface of the first substrate. The plurality of first electrodes are respectively mounted on peripheries of the first transparent electrode. One end of each of the plurality of the first electrodes is connected with the corresponding first leading line.

The second substrate has a bottom surface, a plurality of second transparent electrodes, a plurality of second electrodes, and a plurality of second leading lines.

The bottom surface faces to the top surface of the first substrate.

The plurality of second transparent electrodes are parallelly mounted on the bottom surface and correspond to the first transparent electrode on the top surface of the first substrate to form a plurality of active areas.

Each of the plurality of second electrodes is mounted on one edge of the corresponding second transparent electrode.

The plurality of second leading lines are mounted on a periphery of the bottom surface of the second substrate and correspond to the plurality of the first leading lines.

The plurality of wires are formed alongside the periphery of the bottom surface of the second substrate. One terminal of each of the plurality of wires is connected with the corresponding second electrode, and the other terminal of each of the plurality of wires is connected with the corresponding second leading line.

The insulation layer takes the form of a rectangular frame and is mounted between the top surface of the first substrate and the bottom surface of the second substrate to isolate the first substrate from the second substrate.

The separating layer has a plurality of spacers distributed between the top surface of the first substrate and the bottom surface of the second substrate.

Given the aforementioned structure, multiple active areas can be provided on a same touch panel. By adjusting the size of the active areas, the active areas with larger size can serve as hand-writing pads or regular resistive touch panels, and the active areas with smaller size can serve as touch buttons. The multi-touch detection and dragging feature can also be realized to demonstrate a more flexible and diversified touch.

### BRIEF DESCRIPTION OF THE DRAWINGS

FIG. 1 is an exploded perspective view of a first preferred embodiment of a hybrid touch panel in accordance with the present invention;

FIG. 2 is a top view of the first substrate in FIG. 1;

FIG. 3 is a bottom view of the second substrate in FIG. 1;

FIG. 4 is a top view of a second substrate of a second preferred embodiment of a hybrid touch panel in accordance with the present invention; and

FIG. 5 is an exploded perspective view of a conventional matrix touch panel.

### DETAILED DESCRIPTION OF THE INVENTION

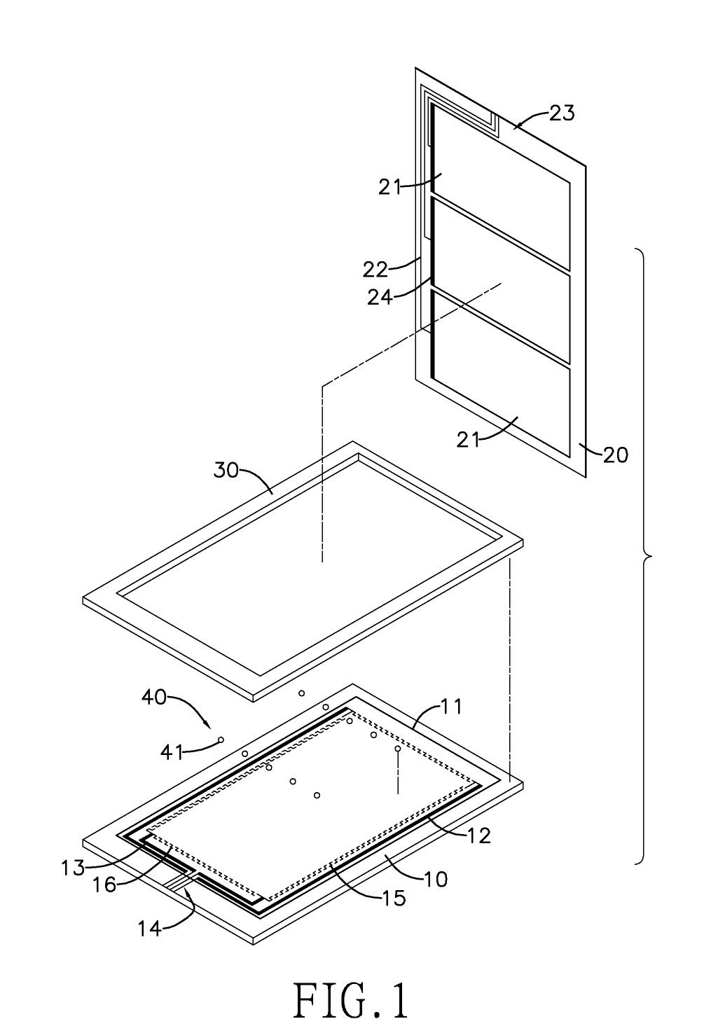

With reference to FIG. 1, a compound resistive touch panel in accordance with a first embodiment of the present invention has a first substrate (10), a second substrate (20), an insulation layer (30) and a separating layer (40).

The first substrate (10) and the second substrate (20) are oppositely mounted. The insulation layer (30) and the separating layer (40) are mounted between the first substrate (10) and the second substrate (20).

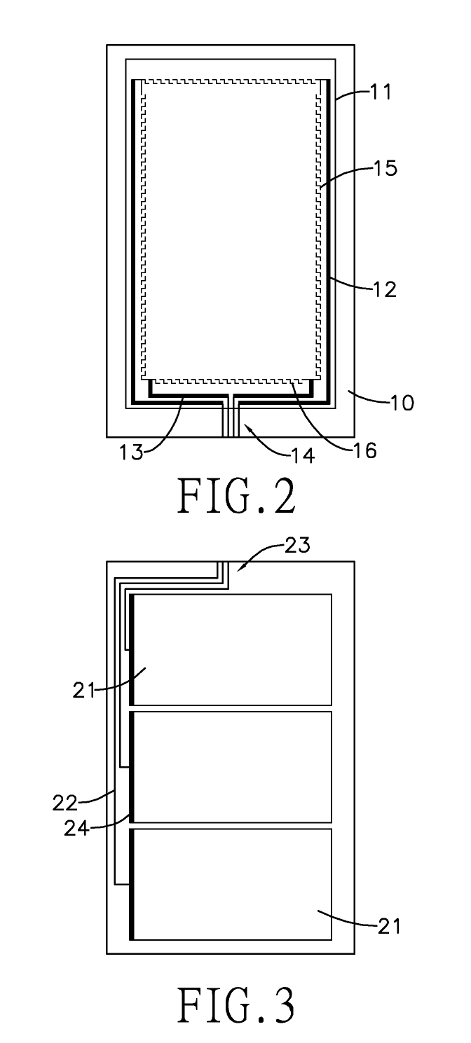

With reference to FIG. 2, the first substrate (10) has a first transparent electrode (11), two long electrodes (12), two short electrodes (13), a plurality first leading lines (14), two bands of long resistive layers (15) and two bands of short resistive layers (16).

The first substrate has a top surface, and the first transparent electrode (Indium Tin Oxide, ITO) (11) is mounted on the top surface. The first transparent electrode (11) occupies most area of the top surface of the first substrate (10). In the present embodiment, the first substrate (10) takes a rectangular form, and the first transparent electrode (11) also takes a rectangular form and has an area slightly smaller than that of the first substrate (10). Two long electrodes (12) are respectively formed alongside two long sides of the first substrate (10). One end of each of the long electrodes (12) is extended alongside a short side of the first substrate (10). A pair of short electrodes (13) are formed alongside the short side and located inside the long electrodes. Two bands of long resistive layers (15) and two bands of short resistive layers (16) are respectively formed alongside two long sides and two short sides of the first transparent electrode (11) and located inside the long electrodes (12) and the short electrodes (13). One end of each of the two long electrodes (12) is connected with the corresponding band of long resistive layer (15) and one end of each of the two short electrodes (13) is commonly connected with one of two bands of short resistive layers (16) to form a four-line loop. A plurality of first leading lines (14) are centrally formed on the corresponding short side of the top surface of the first substrate (10) to respectively connect with the two pairs of the long electrode (12) and the short electrode (13).

With reference to FIGS. 1 and 3, the second substrate (20) is similar to the size of the first substrate (10), and has a plurality of second transparent electrodes (21), a plurality of wires (22), a plurality of second leading lines (23) and a plurality of second electrodes (24).

The second substrate has a bottom surface, and the plurality of second transparent electrodes (21) are parallelly mounted on the bottom surface. The plurality of second transparent electrodes (21) are formed by coating an ITO layer on the bottom surface of the second substrate and etching the ITO layer in formation of multiple parallel transverse trenches. Therefore, the ITO layer can be divided into the plurality of mutually independent second transparent electrodes (21). Those second transparent electrodes (21) correspond to the first transparent electrode (11) on the first substrate (10). Each of the second transparent electrodes (21) together with the first transparent electrode (11) thereunder form an active area, and each active area represents a resistive touch panel.

The plurality of second electrodes (24) are located on a long side of the bottom surface of the second substrate (20). Each of the plurality of second electrodes (24) is mounted on one edge of the corresponding second transparent electrode (21).

The plurality of wires (22) are formed alongside a long side and a short side of the second substrate (20) and are L-shaped. One terminal of each of the plurality of wires (22) is connected with the corresponding second electrode (24). The plurality of second leading lines (23) are centrally formed on the short side of the bottom surface of the second substrate (20) and correspond to the plurality of first leading lines (14). The other terminal of each of the plurality of wires (22) is connected with the corresponding second leading line (23). The number of the wires (22) are determined by the number of the second transparent electrode (21). The above-mentioned wires are printed by a silver material.

The insulation layer (30) also takes the form of a rectangular frame, and is mounted between the first substrate (10) and the second substrate (20). Its frame portion corresponds to the wires (12, 22) on the first substrate (10) and the second substrate (22) and enables the insulation layer to isolate the wires (12, 22). The separating layer (40) is composed of a plurality of spacers (41), which are located inside the insulation layer (30) and scattered between the first substrate (10) and the second substrate (20).

In the present embodiment, the first transparent electrode (11) is entirely formed on the surface of the first substrate (10), and the plurality of independent second transparent electrodes (21) are formed on the bottom surface of the second substrate (20). Each of the second transparent electrodes (21) accompanying with the first transparent electrode (11) forms an active area, thereby realizing the functions of multi-touch detection, multi-touch drag and hand-writing pad. The plurality of second transparent electrodes (21) are horizontally aligned and juxtaposed in a top-to-down fashion and are of the same size. The number and size of the second transparent electrodes depend on the actual requirements in an application.

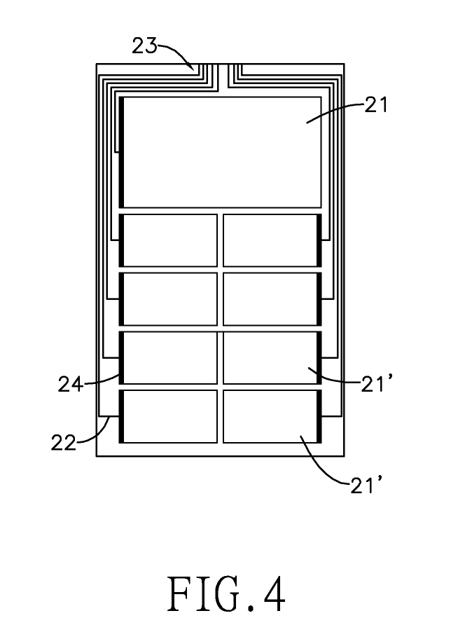

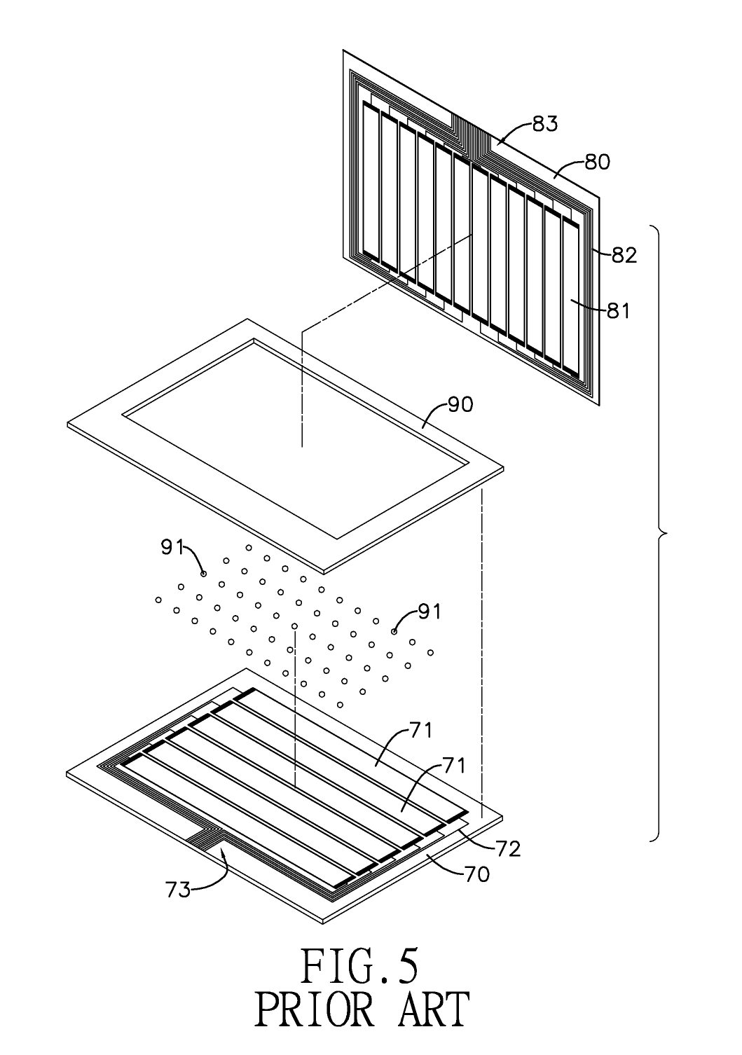

With reference to FIG. 4, a second embodiment of a resistive touch panel differs from the first embodiment in the structure of the second substrate. The second substrate (20) has a plurality of second transparent electrodes (21, 21′) formed on a bottom surface thereof. A second transparent electrode (21) over the top side of FIG. 4 has a larger size so that it can constitute a larger active area together with the first transparent electrode (11) thereunder, and ideally serves as a hand-writing pad. Each of the plurality of second transparent electrodes (21′) with smaller size together with the first transparent electrode (11) thereunder constitutes an independent active area. Since those active areas are all resistive touch panels mutually independent, they can be simultaneously touched, so the functions of multi-touch detection and multi-touch drag can be further implemented. On the other hand, the present invention also achieves the objective of effectively integrating analog touch panels and digital touch panels.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A hybrid touch panel, comprising:
a first substrate having
a top surface;
a first transparent electrode mounted on the top surface;
a plurality of first leading lines mounted on a periphery of the top surface of the first substrate; and
a plurality of first electrodes respectively mounted on peripheries of the first transparent electrode, one end of each of the plurality of the first electrodes connected with the corresponding first leading line;
a second substrate having
a bottom surface facing to the top surface of the first substrate;
a plurality of second transparent electrodes parallelly mounted on the bottom surface and corresponding to the first transparent electrode on the top surface of the first substrate to form a plurality of active areas;
a plurality of second electrodes each mounted on one edge of the corresponding second transparent electrode;
a plurality of second leading lines mounted on a periphery of the bottom surface of the second substrate and corresponding to the plurality of the first leading lines; and
a plurality of wires formed alongside the periphery of the bottom surface of the second substrate, one terminal of each of the plurality of wires connected with the corresponding second electrode and the other terminal of each of the plurality of wires connected with the corresponding second leading line;
an insulation layer taking the form of a rectangular frame and mounted between the top surface of the first substrate and the bottom surface of the second substrate to isolate the first substrate from the second substrate; and
a separating layer having a plurality of spacers distributed between the top surface of the first substrate and the bottom surface of the second substrate.

2. The hybrid touch panel as claimed in claim 1, wherein the second transparent electrodes on the bottom surface of the second substrate have different sizes.

3. The hybrid touch panel as claimed in claim 1, wherein the second substrate takes a rectangular form, the plurality of wires are L-shaped and extended alongside a long edge and a neighboring short edge, and the plurality of second leading lines are formed on the short edge.

4. The hybrid touch panel as claimed in claim 2, wherein the second substrate takes a rectangular form, the plurality of wires are L-shaped and extended alongside a long edge and a neighboring short edge, and the plurality of second leading lines are formed on the short edge.

5. The hybrid touch panel as claimed in claim 3, wherein
the top surface and the first transparent electrode take rectangular forms;
the plurality of first electrodes of the first substrate comprise:
two long electrodes respectively mounted on two long edges of the first transparent electrode and extended alongside a neighboring short edge of the first transparent electrode; and
a pair of short electrodes mounted on and extended alongside the short edge;
the first substrate further comprises:
two bands of long resistive layers and two bands of short resistive layers respectively formed alongside two long edges and two short edges of the first transparent electrode and located inside the long electrodes and the short electrodes, one end of each of the two long electrodes connected with the corresponding band of long resistive layer and one end of each of the two short electrodes is commonly connected with one of two bands of short resistive layers to form a loop; and
the first leading lines are centrally formed on the corresponding short edge of the first substrate to respectively connect with the long electrodes and the short electrodes.

6. The hybrid touch panel as claimed in claim 4, wherein
the top surface and the first transparent electrode take rectangular forms;
the plurality of first electrodes of the first substrate comprise:
two long electrodes respectively mounted on two long edges of the first transparent electrode and extended alongside a neighboring short edge of the first transparent electrode; and
a pair of short electrodes mounted on and extended alongside the short edge;
the first substrate further comprises:
two bands of long resistive layers and two bands of short resistive layers respectively formed alongside two long edges and two short edges of the first transparent electrode and located inside the long electrodes and the short electrodes, one end of each of the two long electrodes connected with the corresponding band of long resistive layer and one end of each of the two short electrodes is commonly connected with one of two bands of short resistive layers to form a loop; and
the first leading lines are centrally formed on the corresponding short edge of the first substrate to respectively connect with the long electrodes and the short electrodes.
